(19) United States
(12) Patent Application Publication
(10) Pub. No.: US 2026/0356759 A1
(43) Pub. Date: Nov. 12, 2026

(54) FORMULATIONS FOR AUTOCLAVE-CURED FIBER CEMENT PRODUCTS

(71) Applicant: JAMES HARDIE TECHNOLOGY LIMITED, Dublin 2 (IE)

(72) Inventors: Mehmet DONMEZ, Rancho Cucamonga, CA (US); Nandakumar NATARAJAN, Rancho Cucamonga, CA (US); Othman ALSHAREEDAH, Rancho Cucamonga, CA (US); Dina SUASNABAR, Rancho Cucamonga, CA (US); Basil Taha NAJI, Upland, CA (US)

(21) Appl. No.: 19/481,049

(22) PCT Filed: May 3, 2024
(86) PCT No.: PCT/US2024/027723

§ 371 Date: Nov. 3, 2025

Related U.S. Application Data
(60) Provisional application No. 63/500,370, filed on May 5, 2023.

(51) Int. Cl. C04B 28/04; C04B 14/06; C04B 14/10; C04B 14/28; C04B 16/06

(52) U.S. Cl. CPC C04B 28/04; C04B 14/06; C04B 14/106; C04B 14/28; C04B 16/06

(57) ABSTRACT

Fiber cement composite formulations for forming hardened fiber cement building articles are described herein. Some embodiments include between 10% and 40% by dry weight of a cementitious material including at least 5% limestone, between 0.5% and 20% by dry weight of calcined soil including calcined clay and a filler, between 30% and 70% by dry weight of silica, and between 1% and 15% by dry weight of cellulose fibers. Also provided herein are fiber cement building articles formed from the disclosed formulations, for example, via the Hatschek process. The fiber cement building articles can be autoclave-cured in a steam pressurized vessel. Synergistic combinations of the components of disclosed fiber cement composite formulations react with one another during autoclaving to form durable phases that exhibit surprisingly high strength, durability, and dimensional stability characteristics in cured fiber cement building articles.

### CROSS-REFERENCE TO RELATED APPLICATIONS

This application is the U.S. National Phase of PCT/US2024/027723, filed on May 3, 2024, entitled “FORMULATIONS FOR AUTOCLAVE-CURED FIBER CEMENT PRODUCTS,” which claims the benefit of U.S. Provisional Application Ser. No. 63/500,370, filed May 5, 2023, entitled “FORMULATIONS FOR AUTOCLAVE-CURED FIBER CEMENT PRODUCTS,” each of which is hereby incorporated by reference in its entirety and for all purposes.

### FIELD

The present disclosure generally relates to fiber cement composite formulations, fiber cement products, and methods of manufacturing the same.

### BACKGROUND

Fiber cement products are frequently used to form exterior and/or interior surfaces of a building structure. Fiber cement-based cladding and interior boards have become popular alternatives to traditional materials in both residential and commercial construction. In addition to fibers and other components, fiber cement formulations generally include a cementitious material. The manufacture of conventional cementitious materials utilized in existing fiber cement formulations (such as Type 1 Portland cement) generates a large carbon footprint due in part to the emissions arising from cement clinker production.

### SUMMARY

The present disclosure provides fiber cement composite formulations that have a significantly reduced carbon footprint in comparison to existing fiber cement formulations. Various embodiments of the disclosed fiber cement composite formulations include cementitious materials having a notable percentage of limestone that acts as a partial replacement for cement clinker. In various embodiments, the disclosed cementitious materials are combined with synergistic amounts of calcined clay (for example, as part of a calcined soil), silica, and fibers (such as cellulose fibers) that desirably react with one another in an autoclave-cure environment to form durable phases which exhibit surprisingly high strength, durability, and dimensional stability characteristics in cured fiber cement products.

Disclosed herein is a fiber cement composite formulation comprising: between 10% and 40% by dry weight of a cementitious material; between 0.5% and 20% by dry weight of calcined soil; between 30% and 70% by dry weight of silica; and between 1% and 15% by dry weight of cellulose fibers. The cementitious material can comprise: between 80% and 95% by dry weight of ground Portland cement clinker having a median particle size between 10 μm and 30 μm; and between 5% and 20% by dry weight of limestone having a median particle size between 5 μm and 30 μm. The calcined soil can comprise: between 20% and 90% by dry weight of calcined clay having a median particle size between 5 μm and 30 μm; and between 10% and 80% by dry weight of a filler comprising quartz having a median particle size between 200 μm and 800 μm. The calcined clay can comprise metakaolin. The silica can have a median particle size between 5 μm and 40 μm. The fiber cement composite formulation can be configured to be autoclave-cured in a steam pressurized vessel at a temperature of at least 150 °C to form a solid fiber cement building article.

In some embodiments, said fiber cement composite formulation comprises between 15% and 35% by dry weight of said cementitious material. In some embodiments, said fiber cement composite formulation comprises between 20% and 30% by dry weight of said cementitious material. In some embodiments, said cementitious material comprises between 8% and 15% by dry weight of said limestone. In some embodiments, said fiber cement composite formulation comprises less than 30% by dry weight of said ground Portland cement clinker. In some embodiments, said fiber cement composite formulation comprises between 1% and 5% by dry weight of said limestone. In some embodiments, said median particle size of said ground Portland cement clinker is between 12 μm and 16 μm. In some embodiments, said median particle size of said limestone is between 9 μm and 25 μm.

In some embodiments, said fiber cement composite formulation comprises between 2% and 8% by dry weight of said calcined soil. In some embodiments, said calcined soil comprises between 20% and 50% by dry weight of calcined clay. In some embodiments, said median particle size of said calcined clay is between 10 μm and 15 μm. In some embodiments, said median particle size of said filler in said calcined soil is between 300 μm and 600 μm. In some embodiments, a ratio of said calcined clay to said filler in said calcined soil is between 0.1 and 0.5. In some embodiments, said fiber cement composite formulation comprises between 0.5% and 5% by dry weight of said calcined clay.

In some embodiments, said fiber cement composite formulation comprises between 40% and 60% by dry weight of said silica. In some embodiments, said median particle size of said silica is between 10 μm and 25 μm. In some embodiments, an amount of said silica in said fiber cement composite formulation is greater than an amount of said cementitious material in said fiber cement composite formulation. In some embodiments, said fiber cement composite formulation comprises between 5% and 10% by dry weight of said cellulose fibers. In some embodiments, said fiber cement composite formulation comprises between 2% and 12% by dry weight of at least one density modifier. In some embodiments, said fiber cement composite formulation comprises less than 10% by dry weight of at least one density modifier.

In some embodiments, a ratio of said silica to said cementitious material in the fiber cement composite formulation is between 1 and 4. In some embodiments, a ratio of said silica to said ground Portland cement clinker in the fiber cement composite formulation is between 1 and 5. In some embodiments, a ratio of said silica to said calcined soil in the fiber cement composite formulation is between 10 and 20. In some embodiments, a ratio of said calcined soil to said cementitious material in the fiber cement composite formulation is between 0.1 and 0.4. In some embodiments, a ratio of said calcined soil to said ground Portland cement clinker in the fiber cement composite formulation is between 0.1 and 0.5. In some embodiments, a ratio of said calcined soil to said limestone in the fiber cement composite formulation is between 1 and 2. In some embodiments, a ratio of said calcined clay to said cementitious material in the fiber cement composite formulation is between 0.01 and 0.06. In some embodiments, a ratio of said calcined clay to said ground Portland cement clinker in the fiber cement composite formulation is between 0.01 and 0.08. In some embodiments, a ratio of said calcined clay to said limestone in the fiber cement composite formulation is between 0.1 and 0.5.

In some embodiments: the limestone in said cementitious material is a first quantity of limestone of the fiber cement composite formulation; and the fiber cement composite formulation further comprises a second quantity of limestone. In some embodiments, a total amount of limestone in the fiber cement composite formulation that includes the first and second quantities of limestone comprises between 1% and 20% of the dry weight of the fiber cement composite formulation. In some embodiments: said first quantity of limestone comprises between 1% and 5% of the dry weight of the fiber cement composite formulation; and said second quantity of limestone comprises between 5% and 20% of the dry weight of the fiber cement composite formulation. In some embodiments, said first quantity of limestone is less than the second quantity of limestone. A fiber cement building article can comprise any of the fiber cement composite formulations disclosed above. The fiber cement building article can be a plank or panel.

Disclosed herein is a fiber cement composite formulation comprising: between 10% and 40% by dry weight of a cementitious material, said cementitious material comprising at least 5% by dry weight of limestone; between 0.5% and 10% by dry weight of calcined clay; silica; and between 1% and 15% by dry weight of fibers; wherein the fiber cement composite formulation is configured to be autoclave-cured in a steam pressurized vessel at a temperature of at least 150 °C to form a solid fiber cement building article.

In some embodiments, said cementitious material further comprises ground Portland cement clinker. In some embodiments, said cementitious material comprises between 80% and 95% by dry weight of said ground Portland cement clinker and between 5% and 20% by dry weight of said limestone. In some embodiments, said ground Portland cement clinker comprises a median particle size between 10 μm and 20 μm. In some embodiments, said median particle size of said ground Portland cement clinker is between 12 μm and 16 μm. In some embodiments, said fiber cement composite formulation comprises between 15% and 30% by dry weight of said ground Portland cement clinker. In some embodiments, said limestone comprises a median particle size between 5 μm and 30 μm. In some embodiments, said median particle size of said limestone is between 9 μm and 25 μm. In some embodiments, said fiber cement composite formulation comprises between 15% and 35% by dry weight of said cementitious material. In some embodiments, said fiber cement composite formulation comprises between 20% and 30% by dry weight of said cementitious material. In some embodiments, said cementitious material comprises between 8% and 15% by dry weight of said limestone. In some embodiments, a ratio of said ground Portland cement clinker to said limestone in said cementitious material is between 5 and 10.

In some embodiments, said fiber cement composite formulation comprises between 1% and 20% by dry weight of calcined soil, said calcined soil comprising between 20% and 90% by dry weight of said calcined clay and between 10% and 80% by dry weight of a filler. In some embodiments, said fiber cement composite formulation comprises between 2% and 8% by dry weight of said calcined soil. In some embodiments, said calcined soil comprises between 20% and 50% by dry weight of said calcined clay. In some embodiments, said calcined clay comprises a median particle size between 5 μm and 30 μm. In some embodiments, said median particle size of said calcined clay is between 10 μm and 15 μm. In some embodiments, said filler in said calcined soil comprises a median particle size between 200 μm and 800 μm. In some embodiments, said median particle size of said filler in said calcined soil is between 300 μm and 600 μm. In some embodiments, a ratio of said calcined clay to said filler in said calcined soil is between 0.1 and 0.5. In some embodiments, said filler comprises quartz. In some embodiments, said calcined clay comprises metakaolin.

In some embodiments, said fiber cement composite formulation comprises between 40% and 60% by dry weight of said silica. In some embodiments, an amount of said silica in said fiber cement composite formulation is greater than an amount of said cementitious material in said fiber cement composite formulation. In some embodiments, said silica comprises a median particle size between 5 μm and 40 μm. In some embodiments, said median particle size of said silica is between 10 μm and 25 μm. In some embodiments, said fiber cement composite formulation comprises between 5% and 10% by dry weight of said fibers. In some embodiments, said fibers comprise cellulose fibers. In some embodiments, the fiber cement composite formulation further comprises between 2% and 12% by dry weight of at least one density modifier. In some embodiments, said fiber cement composite formulation comprises less than 10% by dry weight of at least one density modifier.

In some embodiments, a ratio of said silica to said cementitious material in the fiber cement composite formulation is between 1 and 4. In some embodiments, said cementitious material comprises ground Portland cement clinker and wherein a ratio of said silica to said ground Portland cement clinker in the fiber cement composite formulation is between 1 and 5.

In some embodiments, a ratio of said calcined clay to said cementitious material in the fiber cement composite formulation is between 0.01 and 0.06. In some embodiments, a ratio of said calcined clay to said limestone in the fiber cement composite formulation is between 0.1 and 0.5. In some embodiments, said fiber cement composite formulation comprises calcined soil, said calcined soil comprising said calcined clay and a filler, and wherein a ratio of said silica to said calcined soil in the fiber cement composite formulation is between 10 and 20. In some embodiments, a ratio of said calcined soil to said cementitious material in the fiber cement composite formulation is between 0.1 and 0.4. In some embodiments, said cementitious material further comprises ground Portland cement clinker, and wherein a ratio of said calcined soil to said ground Portland cement clinker in the fiber cement composite formulation is between 0.1 and 0.5. In some embodiments, a ratio of said calcined soil to said limestone in the fiber cement composite formulation is between 1 and 2. In some embodiments, said cementitious material comprises ground Portland cement clinker, and wherein a ratio of said calcined clay to said ground Portland cement clinker in the fiber cement composite formulation is between 0.01 and 0.08.

In some embodiments: the limestone in said cementitious material is a first quantity of limestone of the fiber cement composite formulation; and the fiber cement composite formulation further comprises a second quantity of limestone. In some embodiments, a total amount of limestone in the fiber cement composite formulation that includes the first and second quantities of limestone comprises between 1% and 20% of the dry weight of the fiber cement composite formulation. In some embodiments: said first quantity of limestone comprises between 1% and 5% of the dry weight of the fiber cement composite formulation; and said second quantity of limestone comprises between 5% and 20% of the dry weight of the fiber cement composite formulation. In some embodiments, said first quantity of limestone is less than the second quantity of limestone. In some embodiments, said fiber cement composite formulation comprises between 0.5% and 5% by dry weight of said calcined clay. A fiber cement building article can comprise any of the fiber cement composite formulations disclosed above. The fiber cement building article can be a plank or panel.

Disclosed herein is a method of manufacturing a fiber cement building article, the method comprising: forming the fiber cement building article from a fiber cement composite formulation; and curing the fiber cement building article in a steam pressurized vessel at a temperature between 120 °C and 200 °C. The fiber cement composite formulation can comprise: between 10% and 40% by dry weight of a cementitious material, said cementitious material comprising at least 5% by dry weight of limestone; between 0.5% and 10% by dry weight of calcined clay; between 10% and 70% by dry weight of silica; and between 1% and 15% by dry weight of fibers.

In some embodiments, said curing comprises curing the fiber cement building article in an autoclave. In some embodiments, said curing comprises curing the fiber cement building article in said autoclave at a temperature of between 120 °C and 180 °C. In some embodiments, said curing comprises curing the fiber cement building article in said autoclave at a temperature of between 150 °C and 160 °C. In some embodiments, said curing comprises curing the fiber cement building article in said autoclave for a time period between 8 hours and 16 hours. In some embodiments, said forming the fiber cement building article from said fiber cement composite formulation comprises using a Hatschek process.

In some embodiments, said cementitious material further comprises ground Portland cement clinker. In some embodiments, said cementitious material comprises between 80% and 95% by dry weight of said ground Portland cement clinker and between 5% and 20% by dry weight of said limestone. In some embodiments, said ground Portland cement clinker comprises a median particle size between 10 μm and 20 μm. In some embodiments, said limestone comprises a median particle size between 5 μm and 30 μm. In some embodiments, said fiber cement composite formulation comprises between 15% and 35% by dry weight of said cementitious material.

In some embodiments, said fiber cement composite formulation comprises between 1% and 20% by dry weight of calcined soil, said calcined soil comprising between 20% and 90% by dry weight of said calcined clay and between 10% and 80% by dry weight of a filler. In some embodiments, said fiber cement composite formulation comprises between 2% and 8% by dry weight of said calcined soil. In some embodiments, said calcined soil comprises between 20% and 50% by dry weight of said calcined clay. In some embodiments, said calcined clay comprises a median particle size between 5 μm and 30 μm. In some embodiments, said filler in said calcined soil comprises a median particle size between 200 μm and 800 μm. In some embodiments, a ratio of said calcined clay to said filler in said calcined soil is between 0.1 and 0.5. In some embodiments, said filler comprises quartz. In some embodiments, said calcined clay comprises metakaolin.

In some embodiments, said fiber cement composite formulation comprises between 40% and 60% by dry weight of said silica. In some embodiments, an amount of said silica in said fiber cement composite formulation is greater than an amount of said cementitious material in said fiber cement composite formulation. In some embodiments, said silica comprises a median particle size between 5 μm and 40 μm. In some embodiments, said fiber cement composite formulation comprises between 5% and 10% by dry weight of said fibers. In some embodiments, said fibers comprise cellulose fibers. In some embodiments, the fiber cement composite formulation further comprises between 2% and 12% by dry weight of at least one density modifier.

In some embodiments, a ratio of said silica to said cementitious material in the fiber cement composite formulation is between 1 and 4. In some embodiments, said cementitious material comprises ground Portland cement clinker, and wherein a ratio of said silica to said ground Portland cement clinker in the fiber cement composite formulation is between 1 and 5. In some embodiments, a ratio of said calcined clay to said cementitious material in the fiber cement composite formulation is between 0.01 and 0.06. In some embodiments, a ratio of said calcined clay to said limestone in the fiber cement composite formulation is between 0.1 and 0.5. In some embodiments, said fiber cement composite formulation comprises calcined soil, said calcined soil comprising said calcined clay and a filler, and wherein a ratio of said silica to said calcined soil in the fiber cement composite formulation is between 10 and 20. In some embodiments, a ratio of said calcined soil to said cementitious material in the fiber cement composite formulation is between 0.1 and 0.4. In some embodiments, said cementitious material further comprises ground Portland cement clinker and wherein a ratio of said calcined soil to said ground Portland cement clinker in the fiber cement composite formulation is between 0.1 and 0.5. In some embodiments, a ratio of said calcined soil to said limestone in the fiber cement composite formulation is between 1 and 2. In some embodiments, said cementitious material comprises ground Portland cement clinker, and wherein a ratio of said calcined clay to said ground Portland cement clinker in the fiber cement composite formulation is between 0.01 and 0.08.

In some embodiments: the limestone in said cementitious material is a first quantity of limestone of the fiber cement composite formulation; and the fiber cement composite formulation further comprises a second quantity of limestone. In some embodiments, a total amount of limestone in the fiber cement composite formulation that includes the first and second quantities of limestone comprises between 1% and 20% of the dry weight of the fiber cement composite formulation. In some embodiments: said first quantity of limestone comprises between 1% and 5% of the dry weight of the fiber cement composite formulation; and said second quantity of limestone comprises between 5% and 20% of the dry weight of the fiber cement composite formulation. In some embodiments, said first quantity of limestone is less than the second quantity of limestone. In some embodiments, said fiber cement composite formulation comprises between 0.5% and 5% by dry weight of said calcined clay.

Disclosed herein is a fiber cement composite formulation comprising: between 10% and 30% by dry weight of Portland cement; between 10% and 40% by dry weight of silica having a mean particle size between 1 μm and 20 μm; between 20% and 60% by dry weight of limestone; between 0.5% and 10% by dry weight of calcined clay; and between 1% and 15% by dry weight of fibers. In some embodiments, the fiber cement composite formulation comprises between 15% and 25% by dry weight of said Portland cement. In some embodiments, the fiber cement composite formulation comprises between 20% and 40% by dry weight of said silica. In some embodiments, said mean particle size of said silica is between 10 μm and 15 μm. In some embodiments, said mean particle size of said silica is less than 15 μm. In some embodiments, the fiber cement composite formulation comprises between 25% and 50% by dry weight of said limestone. In some embodiments, said limestone comprises a mean particle size between 20 μm and 30 μm. In some embodiments, the fiber cement composite formulation comprises between 0.5% and 5% by dry weight of said calcined clay. In some embodiments, the fiber cement composite formulation comprises between 5% and 10% by dry weight of said fibers. In some embodiments, the fiber cement composite formulation comprises between 1% and 20% by dry weight of calcined soil, said calcined soil comprising said calcined clay and a filler. In some embodiments, the fiber cement composite formulation comprises between 4% and 10% by dry weight of said calcined soil. In some embodiments, said calcined soil comprises between 20% and 50% by dry weight of said calcined clay. In some embodiments, a ratio of said Portland cement to said limestone in the fiber cement composite formulation is between 0.2 and 0.9. In some embodiments, a ratio of said Portland cement to said limestone in the fiber cement composite formulation is less than 1. A fiber cement building article can comprise any of the fiber cement composite formulations described above. A method of manufacturing a fiber cement building article can comprise: forming the fiber cement building article from any of the fiber cement composite formulations described above; and curing the fiber cement building article in a steam pressurized vessel at a temperature between 120 °C and 200 °C.

Disclosed herein is a fiber cement composite formulation comprising cement, limestone, calcined clay, silica, and fibers. In some embodiments, the fiber cement composite formulation comprises between 10% and 30% by dry weight of cement. In some embodiments, the fiber cement composite formulation comprises between 15% and 25% by dry weight of cement. In some embodiments, the cement comprises ground Portland cement clinker. In some embodiments, the fiber cement composite formulation comprises between 1% and 20% of limestone. In some embodiments, the fiber cement composite formulation comprises between 1% and 5% of limestone. In some embodiments, the fiber cement composite formulation comprises between 10% and 20% of limestone. In some embodiments, the fiber cement composite formulation comprises between 0.5% and 10% by dry weight of calcined clay. In some embodiments, the fiber cement composite formulation comprises between 0.5% and 5% by dry weight of calcined clay. In some embodiments, the fiber cement composite formulation comprises between 0.5% and 2% by dry weight of calcined clay. In some embodiments, the fiber cement composite formulation comprises calcined soil which includes the calcined clay and a filler (for example, quartz). In some embodiments, the fiber cement composite formulation comprises between 0.5% and 20% of said calcined soil. In some embodiments, the fiber cement composite formulation comprises between 2% and 6% of said calcined soil. In some embodiments, the fiber cement composite formulation comprises between 10% and 70% by dry weight of silica. In some embodiments, the fiber cement composite formulation comprises between 40% and 70% by dry weight of silica. In some embodiments, the fiber cement composite formulation comprises between 40% and 60% by dry weight of silica. In some embodiments, the fiber cement composite formulation comprises between 1% and 15% by dry weight of fibers. In some embodiments, the fiber cement composite formulation comprises between 5% and 10% by dry weight of fibers. In some embodiments, the fibers comprise cellulose fibers.

Disclosed herein is a fiber cement composite formulation comprising: between 10% and 40% by dry weight of a cementitious material; between 1% and 20% by dry weight of calcined soil; between 30% and 80% by dry weight of silica; between 1% and 15% by dry weight of cellulose fibers; and between 2% and 12% by dry weight of at least one density modifier; wherein the fiber cement composite formulation is configured to be autoclave-cured in a steam pressurized vessel at a temperature of at least 150 °C to form a solid fiber cement building article. The cementitious material can comprise: between 80% and 95% by dry weight of ground Portland cement clinker having a median particle size between 10 μm and 20 μm; and between 5% and 20% by dry weight of limestone having a median particle size between 5 μm and 30 μm. The calcined soil can comprise: between 40% and 80% by dry weight of calcined clay having a median particle size between 5 μm and 30 μm, said calcined clay comprising metakaolin; and between 20% and 60% by dry weight of a filler having a median particle size between 200 μm and 800 μm. The silica can have a median particle size between 5 μm and 40 μm. Such filler can comprise an inert filler (such as quartz).

In some embodiments, said fiber cement composite formulation comprises between 15% and 35% by dry weight of said cementitious material. In some embodiments, said fiber cement composite formulation comprises between 20% and 30% by dry weight of said cementitious material. In some embodiments, said cementitious material comprises between 8% and 15% by dry weight of said limestone. In some embodiments, said fiber cement composite formulation comprises between 15% and 30% by dry weight of said ground Portland cement clinker. In some embodiments, said fiber cement composite formulation comprises between 1% and 5% by dry weight of said limestone. In some embodiments, said median particle size of said ground Portland cement clinker is between 12 μm and 16 μm. In some embodiments, said median particle size of said limestone is between 9 μm and 25 μm. In some embodiments, a ratio between said ground Portland cement clinker and said limestone in said cementitious material is between 4 and 20.

In some embodiments, said fiber cement composite formulation comprises between 4% and 18% by dry weight of said calcined soil. In some embodiments, said calcined soil comprises at least 50% by dry weight of said calcined clay. In some embodiments, said calcined soil comprises at least 60% by dry weight of said calcined clay. In some embodiments, an amount of said calcined clay in said calcined soil is greater than an amount of said filler in said calcined soil. In some embodiments, said calcined soil comprises less than 50% by dry weight of said filler. In some embodiments, said calcined soil comprises between 50% and 70% by dry weight of calcined clay and between 30% and 50% by dry weight of said filler. In some embodiments, said median particle size of said calcined clay is between 10 μm and 15 μm. In some embodiments, said median particle size of said filler is between 300 μm and 600 μm. In some embodiments, a ratio of said calcined clay to said filler in said calcined soil is between 1 and 2.5. In some embodiments, a ratio of said calcined clay to said filler in said calcined soil is 2. In some embodiments, said fiber cement composite formulation comprises between 2% and 10% of said calcined clay. In some embodiments, said fiber cement composite formulation comprises between 40% and 70% by dry weight of said silica. In some embodiments, said fiber cement composite formulation comprises at least 50% by dry weight of said silica. In some embodiments, said median particle size of said silica is between 10 μm and 25 μm. In some embodiments, an amount of said silica in said fiber cement composite formulation is greater than an amount of said cementitious material in said fiber cement composite formulation. In some embodiments, an amount of said silica in said fiber cement composite formulation is greater than an amount of said calcined soil in said fiber cement composite formulation.

In some embodiments, said fiber cement composite formulation comprises between 5% and 10% by dry weight of said cellulose fibers. In some embodiments, said fiber cement composite formulation comprises between 5% and 10% by dry weight of said at least one density modifier. In some embodiments, said fiber cement composite formulation comprises less than 10% by dry weight of said at least one density modifier. In some embodiments, a ratio of said silica to said cementitious material in said fiber cement composite formulation is between 1 and 8. In some embodiments, a ratio of said silica to said ground Portland cement clinker in said fiber cement composite formulation is between 1 and 8.

Disclosed herein is a fiber cement composite formulation comprising: between 10% and 40% by dry weight of a cementitious material, said cementitious material comprising at least 5% by dry weight of limestone; between 1% and 20% by dry weight of calcined clay; between 30% and 80% by dry weight of silica; and between 1% and 15% by dry weight of fibers.

In some embodiments, said cementitious material further comprises ground Portland cement clinker. In some embodiments, said cementitious material comprises between 80% and 95% by dry weight of said ground Portland cement clinker and between 5% and 20% by dry weight of said limestone. In some embodiments, said ground Portland cement clinker comprises a median particle size between 10 μm and 20 μm. In some embodiments, said median particle size of said ground Portland cement clinker is between 12 μm and 16 μm. In some embodiments, said fiber cement composite formulation comprises between 15% and 30% by dry weight of said ground Portland cement clinker. In some embodiments, said limestone comprises a median particle size between 5 μm and 30 μm. In some embodiments, said median particle size of said limestone is between 9 μm and 25 μm. In some embodiments, said fiber cement composite formulation comprises between 15% and 35% by dry weight of said cementitious material. In some embodiments, said fiber cement composite formulation comprises between 20% and 30% by dry weight of said cementitious material. In some embodiments, said cementitious material comprises between 8% and 15% by dry weight of said limestone. In some embodiments, a ratio between said ground Portland cement clinker and said limestone in said cementitious material is between 4 and 20.

In some embodiments, said fiber cement composite formulation comprises between 1% and 20% by dry weight of calcined soil, said calcined soil comprising between 40% and 80% by dry weight of said calcined clay and between 20% and 60% by dry weight of a filler. In some embodiments, said fiber cement composite formulation comprises between 4% and 18% by dry weight of said calcined soil. In some embodiments, said calcined soil comprises at least 50% by dry weight of said calcined clay. In some embodiments, said calcined soil comprises at least 60% by dry weight of said calcined clay. In some embodiments, an amount of said calcined clay in said calcined soil is greater than an amount of said filler in said calcined soil. In some embodiments, said filler comprises less than 50% by dry weight of said calcined soil. In some embodiments, said calcined soil comprises between 50% and 70% by dry weight of said calcined clay and between 30% and 50% by dry weight of said filler. In some embodiments, said calcined clay comprises a median particle size between 5 μm and 30 μm. In some embodiments, said median particle size of said calcined clay is between 10 μm and 15 μm. In some embodiments, said filler comprises a median particle size between 200 μm and 800 μm. In some embodiments, said median particle size of said filler is between 300 μm and 600 μm. In some embodiments, a ratio of said calcined clay to said filler in said calcined soil is between 1 and 2.5. In some embodiments, a ratio of said calcined clay to said filler in said calcined soil is 2. In some embodiments, said filler comprises quartz. In some embodiments, said calcined clay comprises metakaolin.

In some embodiments, said fiber cement composite formulation comprises between 40% and 70% by dry weight of said silica. In some embodiments, said fiber cement composite formulation comprises at least 50% by dry weight of said silica. In some embodiments, an amount of said silica in said fiber cement composite formulation is greater than an amount of said cementitious material in said fiber cement composite formulation. In some embodiments, an amount of said silica in said fiber cement composite formulation is greater than an amount of said calcined soil in said fiber cement composite formulation. In some embodiments, said silica comprises a median particle size between 5 μm and 40 μm. In some embodiments, said median particle size of said silica is between 10 μm and 25 μm.

In some embodiments, said fiber cement composite formulation comprises between 5% and 10% by dry weight of said fibers. In some embodiments, said fibers comprise cellulose fibers. In some embodiments, said fiber cement composite formulation further comprises between 2% and 12% by dry weight of at least one density modifier. In some embodiments, said fiber cement composite formulation comprises between 5% and 10% by dry weight of said at least one density modifier. In some embodiments, said fiber cement composite formulation comprises less than 10% by dry weight of said at least one density modifier.

In some embodiments, a ratio of said silica to said cementitious material in said fiber cement composite formulation is between 1 and 8. In some embodiments, said cementitious material comprises Portland cement clinker, and wherein a ratio of said silica to said Portland cement clinker in said fiber cement composite formulation is between 1 and 8.

Disclosed herein is a method of manufacturing a fiber cement building article, the method comprising: forming the fiber cement building article from a fiber cement composite formulation and curing the fiber cement building article in a steam pressurized vessel at a temperature between 120 °C and 200 °C. The fiber cement composite formulation can comprise: between 10% and 40% by dry weight of a cementitious material, said cementitious material comprising at least 5% by dry weight of limestone; between 1% and 20% by dry weight of calcined clay; between 30% and 80% by dry weight of silica; and between 1% and 15% by dry weight of fibers. In some embodiments, said fibers comprise cellulose fibers.

In some embodiments, said curing comprises curing the fiber cement building article in an autoclave. In some embodiments, said curing comprises curing the fiber cement building article in said autoclave at a temperature of between 120 °C and 180 °C. In some embodiments, said curing comprises curing the fiber cement building article in said autoclave at a temperature of between 150 °C and 160 °C. In some embodiments, said curing comprises curing the fiber cement building article in said autoclave for a time period between 8 hours and 16 hours. In some embodiments, said forming the fiber cement building article from said fiber cement composite formulation comprises using a Hatschek process.

In some embodiments, said cementitious material further comprises ground Portland cement clinker. In some embodiments, said cementitious material comprises between 80% and 95% by dry weight of said ground Portland cement clinker and between 5% and 20% by dry weight of said limestone. In some embodiments, said ground Portland cement clinker comprises a median particle size between 10 μm and 20 μm. In some embodiments, said limestone comprises a median particle size between 5 μm and 30 μm. In some embodiments, said fiber cement composite formulation comprises between 15% and 35% by dry weight of said cementitious material.

In some embodiments, said fiber cement composite formulation comprises between 1% and 20% by dry weight of calcined soil, said calcined soil comprising between 40% and 80% by dry weight of said calcined clay and between 20% and 60% by dry weight of a filler. In some embodiments, said fiber cement composite formulation comprises between 4% and 18% by dry weight of said calcined soil. In some embodiments, said calcined soil comprises at least 50% by dry weight of said calcined clay. In some embodiments, an amount of said calcined clay in said calcined soil is greater than an amount of said filler in said calcined soil. In some embodiments, said filler comprises less than 50% by dry weight of said calcined soil. In some embodiments, said calcined clay comprises a median particle size between 5 μm and 30 μm. In some embodiments, said filler comprises a median particle size between 200 μm and 800 μm.

In some embodiments, a ratio of said calcined clay to said filler is between 1 and 2.5. In some embodiments, said filler comprises quartz. In some embodiments, said calcined clay comprises metakaolin. In some embodiments, said fiber cement composite formulation comprises between 40% and 70% by dry weight of said silica. In some embodiments, an amount of said silica in said fiber cement composite formulation is greater than an amount of said cementitious material in said fiber cement composite formulation. In some embodiments, an amount of said silica in said fiber cement composite formulation is greater than an amount of said calcined soil in said fiber cement composite formulation. In some embodiments, said silica comprises a median particle size between 5 μm and 40 μm. In some embodiments, said fiber cement composite formulation comprises between 5% and 10% by dry weight of said fibers. In some embodiments, said fibers comprise cellulose fibers. In some embodiments, the fiber cement composite formulation further comprises between 2% and 12% by dry weight of at least one density modifier.

In some embodiments, a ratio of said silica to said cementitious material in said fiber cement composite formulation is between 1 and 8. In some embodiments, said cementitious material comprises ground Portland cement clinker and a ratio of said silica to said Portland cement clinker in said fiber cement composite formulation is between 1 and 8.

Disclosed herein is a fiber cement composite formulation comprising: between 10% and 40% by dry weight of a cementitious material, said cementitious material comprising at least 5% by dry weight of limestone; between 1% and 20% by dry weight of calcined clay; between 1% and 15% by dry weight of fibers; and silica. In some embodiments, the silica comprises a remainder of the fiber cement composite formulation. In some embodiments, the fiber cement composite formulation comprises between 30% and 80% by dry weight of silica.

In some embodiments, said cementitious material further comprises ground Portland cement clinker. In some embodiments, said cementitious material comprises between 80% and 95% by dry weight of said ground Portland cement clinker and between 5% and 20% by dry weight of said limestone. In some embodiments, said ground Portland cement clinker comprises a median particle size between 10 μm and 20 μm. In some embodiments, said median particle size of said ground Portland cement clinker is between 12 μm and 16 μm. In some embodiments, said fiber cement composite formulation comprises between 15% and 30% by dry weight of said ground Portland cement clinker. In some embodiments, said limestone comprises a median particle size between 5 μm and 30 μm. In some embodiments, said median particle size of said limestone is between 9 μm and 25 μm. In some embodiments, said fiber cement composite formulation comprises between 15% and 35% by dry weight of said cementitious material. In some embodiments, said fiber cement composite formulation comprises between 20% and 30% by dry weight of said cementitious material. In some embodiments, said cementitious material comprises between 8% and 15% by dry weight of said limestone. In some embodiments, a ratio between said ground Portland cement clinker and said limestone in said fiber cement composite formulation is between 4 and 20.

In some embodiments, said fiber cement composite formulation comprises between 1% and 20% by dry weight of calcined soil, said calcined soil comprising between 40% and 80% by dry weight of said calcined clay and between 20% and 60% by dry weight of a filler. In some embodiments, said fiber cement composite formulation comprises between 4% and 18% by dry weight of said calcined soil. In some embodiments, said calcined soil comprises at least 50% by dry weight of said calcined clay. In some embodiments, said calcined soil comprises at least 60% by dry weight of said calcined clay. In some embodiments, an amount of said calcined clay in said calcined soil is greater than an amount of said filler in said calcined soil. In some embodiments, said filler comprises less than 50% by dry weight of said calcined soil. In some embodiments, said calcined soil comprises between 50% and 70% by dry weight of said calcined clay and between 30% and 50% by dry weight of said filler. In some embodiments, said calcined clay comprises a median particle size between 5 μm and 30 μm. In some embodiments, said median particle size of said calcined clay is between 10 μm and 15 μm. In some embodiments, said filler comprises a median particle size between 200 μm and 800 μm. In some embodiments, said median particle size of said filler is between 300 μm and 600 μm. In some embodiments, a ratio of said calcined clay to said filler in said calcined soil is between 1 and 2.5. In some embodiments, a ratio of said calcined clay to said filler in said calcined soil is 2. In some embodiments, said filler comprises quartz. In some embodiments, said calcined clay comprises metakaolin.

In some embodiments, said fiber cement composite formulation comprises between 40% and 70% by dry weight of said silica. In some embodiments, said fiber cement composite formulation comprises at least 50% by dry weight of said silica. In some embodiments, an amount of said silica in said fiber cement composite formulation is greater than an amount of said cementitious material in said fiber cement composite formulation. In some embodiments, an amount of said silica in said fiber cement composite formulation is greater than an amount of said calcined soil in said fiber cement composite formulation. In some embodiments, said silica comprises a median particle size between 5 μm and 40 μm. In some embodiments, said median particle size of said silica is between 10 μm and 25 μm.

In some embodiments, said fiber cement composite formulation comprises between 5% and 10% by dry weight of said fibers. In some embodiments, said fibers comprise cellulose fibers. In some embodiments, said fiber cement composite formulation further comprises between 2% and 12% by dry weight of at least one density modifier. In some embodiments, said fiber cement composite formulation comprises between 5% and 10% by dry weight of said at least one density modifier. In some embodiments, said fiber cement composite formulation comprises less than 10% by dry weight of said at least one density modifier.

In some embodiments, a ratio of said silica to said cementitious material is between 1 and 8. In some embodiments, said cementitious material comprises ground Portland cement clinker and a ratio of said silica to said ground Portland cement clinker in said fiber cement composite formulation is between 1 and 8.

### BRIEF DESCRIPTION OF THE DRAWINGS

Certain embodiments of the present disclosure will now be described, by way of example only, with reference to the accompanying drawings.

FIG. 1 illustrates an example method of manufacturing a fiber cement product in accordance with aspects of this disclosure.

### DETAILED DESCRIPTION

Disclosed herein are fiber cement composite formulations that have a significantly reduced carbon footprint in comparison to existing formulations. Existing fiber cement formulations utilize Portland cement (such as Type 1 Portland cement) as a cementitious binder/material. Production of cement clinker, a key constituent of such cementitious binders, results in considerable carbon emissions. Various embodiments of the disclosed fiber cement composite formulations include more environmentally-friendly cementitious materials having a notable percentage of limestone that acts as a partial replacement for cement clinker. Advantageously, the disclosed formulations include synergistic combinations of such cementitious materials with calcined clay (for example, as part of a calcined soil), silica, and fibers (such as cellulose fibers) that form durable phases an autoclave-cure environment. Autoclave-cured, fiber cement products formed from disclosed embodiments of these formulation components have been found to exhibit surprisingly high strength (for example, flexural strength), durability, and dimensional stability characteristics (for example, low moisture movement).

Various embodiments of fiber cement composite formulations disclosed herein include a cementitious material, calcined clay (for example, as part of a calcined soil), silica, and fibers. In some embodiments, the fiber cement composite formulation comprises between about 10% and about 50% by dry weight of cementitious material, for example, between about 15% and about 45%, between about 20% and about 40%, between about 25% and about 35%, between about 10% and about 40%, between about 10% and about 30%, between about 10% and about 20%, between about 15% and about 35%, or between about 20% and about 30% by dry weight of cementitious material, or any value or range within or bounded by any of these ranges or values. In some embodiments, the fiber cement composite formulation comprises less than about 60%, less than about 55%, less than about 50%, less than about 45%, less than about 40%, less than about 35%, less than about 30%, or less than about 25% by dry weight of cementitious material. In contrast to conventional fiber cement formulations, various embodiments of the formulations disclosed herein include cementitious materials having limestone as a partial replacement for traditional cement clinker. The disclosed cementitious materials can include at least about 2%, at least about 5%, at least about 10%, at least about 12%, or at least about 15% by dry weight of limestone. As another example, the cementitious materials can include between about 2% and about 40% by dry weight of limestone, for example, between about 5% and about 40%, between about 5% and about 35%, between about 5% and about 30%, between about 5% and about 25%, between about 5% and about 20%, between about 5% and about 15%, between about 5% and about 10%, between about 10% and about 20%, between about 10% and about 15%, or between about 8% and 15% by dry weight of limestone, or any value or range within or bounded by any of these ranges or values. In addition to any of the above-described amounts of limestone, the cementitious materials in the disclosed fiber cement composite formulations can include cement, such as Portland cement clinker (for example, ground Portland cement clinker). The cementitious material in the disclosed fiber cement composite formulations can include between about 50% and about 99% by dry weight of cement (for example, Portland cement clinker), for example, between about 55% and about 90%, between about 60% and about 85%, between about 65% and about 80%, between about 70% and about 75%, between about 75% and about 95%, between about 75% and about 98%, between about 80% and about 99%, between about 80% and about 95%, or between about 80% and about 90% by dry weight of cement (for example, Portland cement clinker), or any value or range within or bounded by any of these ranges or values. In some embodiments, the cementitious material includes less than about 99% by dry weight of cement (for example, Portland cement clinker), for example, less than about 98%, less than about 97%, less than about 96%, less than about 95%, less than about 94%, less than about 93%, less than about 92%, less than about 91%, less than about 90%, less than about 89%, less than about 88%, less than about 87%, less than about 86%, less than about 85%, less than about 84%, less than about 83%, less than about 82%, less than about 81%, or less than about 80% by dry weight of cement (for example, Portland cement clinker).

In some embodiments, the cementitious material includes limestone having a median particle size that is between about 1 μm and about 50 μm, for example, between about 5 μm and about 45 μm, between about 10 μm and about 40 μm, between about 15 μm and about 35 μm, between about 20 μm and about 30 μm, between about 5 μm and about 30 μm, or between about 9 μm and about 25 μm, or any value or range within or bounded by any of these ranges or values.

In some embodiments, the cementitious material includes limestone having a mean particle size that is between about 1 μm and about 80 μm, for example, between about 5 μm and about 75 μm, between about 10 μm and about 70 μm, between about 15 μm and about 65 μm, between about 20 μm and about 60 μm, between about 25 μm and about 55 μm, between about 30 μm and about 50 μm, between about 35 μm and about 45 μm, between about 40 μm and about 50 μm, between about 10 μm and about 50 μm, between about 15 μm and about 45 μm, between about 20 μm and about 40 μm, between about 25 μm and about 35 μm, or between about 20 μm and about 30 μm, or any value or range within or bounded by any of these ranges or values.

In some embodiments, the cementitious material includes Portland cement (for example, ground Portland cement clinker) having a median particle size that is between about 1 μm and about 60 μm, for example, between about 5 μm and about 55 μm, between about 10 μm and about 50 μm, between about 15 μm and about 45 μm, between about 20 μm and about 40 μm, between about 25 μm and about 35 μm, between about 10 μm and about 20 μm, or between about 12 μm and about 16 μm, or any value or range within or bounded by any of these ranges or values.

In some embodiments, the cementitious material includes Portland cement (for example, ground Portland cement clinker) having a mean particle size that is between about 1 μm and about 30 μm, for example, between about 5 μm and about 25 μm, or between about 10 μm and about 20 μm, or any value or range within or bounded by any of these ranges or values.

In some embodiments, a ratio between Portland cement (for example, ground Portland cement clinker) and limestone in the cementitious material of the fiber cement composite formulation is between about 4 and about 20, for example, between about 5 and about 19, between about 6 and about 18, between about 7 and about 17, between about 8 and about 16, between about 9 and about 15, between about 10 and about 14, between about 11 and about 13, between about 5 and about 12, between about 6 and about 11, between about 7 and about 10, between about 5 and about 10, or between about 6 and about 8.

In some embodiments, the fiber cement composite formulation includes between about 5% and about 40% by dry weight of Portland cement (for example, ground Portland cement clinker). For example, the fiber cement composite formulation can include between about 10% and about 35%, between about 15% and about 30%, between about 20% and about 25%, between about 15% and about 25%, between about 15% and about 30%, or between about 10% and about 30% by dry weight of Portland cement (for example, ground Portland cement clinker), or any value or range within or bounded by any of these ranges or values. In some embodiments, the fiber cement composite formulation includes less than about 50% by dry weight of Portland cement (for example, ground Portland cement clinker), for example, less than about 45%, less than about 40%, less than about 35%, less than about 30%, less than about 25%, or less than about 20% by dry weight of Portland cement (for example, ground Portland cement clinker).

In some embodiments, the fiber cement composite formulation includes between about 0.5% and about 8% by dry weight of limestone, for example, between about 1% and about 7.5%, between about 1.5% and about 7%, between about 2% and about 6.5%, between about 2.5% and about 6%, between about 3% and about 5.5%, between about 3.5% and about 5%, between about 4% and about 4.5%, between about 1% and about 5%, between about 1% and about 4.5%, between about 1% and about 4%, between about 1% and about 3.5%, between about 1% and about 3%, between about 1% and about 2.5%, or between about 1% and about 2% by dry weight of limestone, or any value or range within or bounded by any of these ranges or values. In some embodiments, the fiber cement composite formulation includes at least about 0.5% by dry weight of limestone, for example, at least about 1%, at least about 1.5%, at least about 2%, at least about 2.5%, at least about 3%, at least about 3.5%, at least about 4%, at least about 4.5%, at least about 5%, at least about 5.5%, at least about 6%, at least about 6.5%, at least about 7%, or at least about 7.5% by dry weight of limestone.

The fiber cement composite formulations disclosed herein can include calcined clay. Clays generally contain minerals such as illite, smectite, and kaolinite, which can become pozzolanic when calcined at temperatures between 700 °C and 900 °C due to dehydroxylation reactions and amorphous aluminosilicate formation. In some embodiments, the calcined clay included in the fiber cement composite formulation comprises dehydroxylated clay (metakaolin). In some embodiments, the fiber cement composite formulation comprises between about 1% and about 15% by dry weight of calcined clay, for example, between about 2% and about 14%, between about 3% and about 13%, between about 4% and about 12%, between about 5% and about 11%, between about 6% and about 10%, between about 7% and about 9%, between about 2% and about 9%, or between about 3% and about 8% by dry weight of calcined clay, or any value or range within or bounded by any of these ranges or values. In some embodiments, the fiber cement composite formulation comprises between about 0.5% and about 10% by dry weight of calcined clay, for example, between about 1% and about 10%, between about 2% and about 9%, between about 3% and about 8%, between about 4% and about 7%, between about 5% and about 6%, between about 0.5% and about 5%, between about 0.5% and about 4%, between about 0.5% and about 3%, or between about 0.5% and about 2% by dry weight of calcined clay, or any value or range within or bounded by any of these ranges or values. In some embodiments, the fiber cement composite formulation comprises at least about 0.5%, at least about 1%, at least about 2%, at least about 3%, at least about 4%, at least about 5%, at least about 6%, at least about 7%, at least about 8%, at least about 9%, or at least about 10% by dry weight of calcined clay. In some embodiments, the fiber cement composite formulation comprises less than about 15%, less than about 14%, less than about 13%, less than about 12%, less than about 11%, less than about 10%, less than about 9%, less than about 8%, less than about 7%, less than about 6%, less than about 5%, less than about 4%, less than about 3%, or less than about 2% by dry weight of calcined clay.

In some embodiments, the calcined clay has a median particle size that is between about 1 μm and about 40 μm, for example, between about 5 μm and about 40 μm, between about 10 μm and about 35 μm, between about 15 μm and about 30 μm, between about 20 μm and about 25 μm, between about 5 μm and about 15 μm, between about 5 μm and about 30 μm, or between about 10 μm and about 15 μm, or any value or range within or bounded by any of these ranges or values.

In some embodiments, the calcined clay has a mean particle size that is between about 1 μm and about 40 μm, for example, between about 5 μm and about 40 μm, between about 10 μm and about 35 μm, between about 15 μm and about 30 μm, between about 20 μm and about 25 μm, or between about 5 μm and about 20 μm, or any value or range within or bounded by any of these ranges or values.

In some embodiments, the fiber cement composite formulation includes calcined soil. The calcined soil can comprise clay-containing soil that has been mined, ground, and calcined. The calcined soil can include calcined clay (for example, calcined clay having any of the properties discussed elsewhere herein) and a filler (for example, an inert filler). Such filler can comprise quartz, mica, calcium carbonates, iron oxides, sulfides, and/or feldspar. In some embodiments, the fiber cement composite formulation comprises between about 0.5% and about 20% by dry weight of calcined soil, for example, between about 1% and about 20%, between about 2% and about 19%, between about 3% and about 18%, between about 4% and about 17%, between about 5% and about 16%, between about 6% and about 15%, between about 7% and about 14%, between about 8% and about 13%, between about 9% and about 12%, between about 10% and about 11%, between about 5% and about 16%, between about 2% and about 15%, between about 2% and about 10%, between about 2% and about 8%, or between about 2% and about 6% by dry weight of calcined soil, or any value or range within or bounded by any of these ranges or values. Depending on the extent of pre-calcination particle size reduction, the calcined soil can have a particle size distribution between about 1 μm and about 1000 μm, for example, between about 1 μm and about 950 μm, between about 1 μm and about 900 μm, between about 1 μm and about 850 μm, between about 1 μm and about 800 μm, between about 1 μm and about 750 μm, between about 1 μm and about 700 μm, between about 1 μm and about 650 μm, between about 1 μm and about 600 μm, between about 1 μm and about 550 μm, between about 1 μm and about 500 μm, between about 1 μm and about 450 μm, between about 1 μm and about 400 μm, between about 1 μm and about 350 μm, between about 1 μm and about 300 μm, between about 1 μm and about 250 μm, or between about 1 μm and about 200 μm, or any value or range within or bounded by any of these ranges or values.

In some embodiments, the calcined soil includes a filler (for example, quartz) having a median particle size that is between about 100 μm and about 800 μm, for example, between about 150 μm and about 750 μm, between about 200 μm and about 700 μm, between about 250 μm and about 650 μm, between about 300 μm and about 600 μm, between about 350 μm and about 550 μm, or between about 400 μm and about 500 μm, or any value or range within or bounded by any of these ranges or values.

In some embodiments, the fiber cement composite formulation includes calcined soil that comprises between about 20% and about 90% by dry weight of calcined clay, for example, between about 30% and about 90% between about 35% and about 85%, between about 40% and about 80%, between about 45% and about 75%, between about 50% and about 70%, between about 55% and about 65%, between about 50% and about 75%, between about 50% and about 80%, between about 50% and about 90%, between about 25% and about 85%, between about 30% and about 80%, between about 35% and about 75%, between about 40% and about 70%, between about 45% and about 65%, between about 50% and about 60%, between about 20% and about 50%, between about 20% and about 40%, or between about 20% and about 30% by dry weight of calcined clay, or any value or range within or bounded by any of these ranges or values. In some embodiments, the calcined soil comprises at least about 20% by dry weight of calcined clay, for example, at least about 25%, at least about 30%, at least about 35%, at least about 40%, at least about 45%, at least about 50%, at least about 55%, at least about 60%, at least about 65%, at least about 70%, or at least about 75% by dry weight of calcined clay.

In some embodiments, the fiber cement composite formulation includes calcined soil that comprises between about 10% and about 80% by dry weight of filler (for example, quartz), for example, between about 10% and about 70%, between about 15% and about 65%, between about 20% and about 60%, between about 25% and about 55%, between about 30% and about 50%, between about 35% and about 45%, between about 10% and about 40%, between about 10% and about 35%, between about 10% and about 30%, between about 10% and about 25%, between about 10% and about 20%, between about 15% and about 75%, between about 20% and about 70%, between about 25% and about 65%, between about 30% and about 60%, between about 35% and about 55%, or between about 40% and about 50%, or any value or range within or bounded by any of these ranges or values. In some embodiments, the fiber cement composite formulation includes calcined soil that comprises at least about 5% by dry weight of the filler (for example, quartz), for example, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, or at least about 75% by dry weight of the filler. In some embodiments, the fiber cement composite formulation includes calcined soil that comprises less than about 85% by dry weight of the filler, for example, less than about 80%, less than about 75%, less than about 70%, less than about 65%, less than about 60%, less than about 55%, less than about 50%, less than about 45%, less than about 40%, less than about 35%, less than about 30%, less than about 25%, less than about 20%, less than about 15%, or less than about 10% by dry weight of the filler. In some embodiments, a ratio of the calcined clay to the filler in the calcined soil of the fiber cement composite formulation is between about 1 and about 5, for example, between about 1.5 and about 4.5, between about 2 and about 4, between about 2.5 and about 3.5, between about 1 and about 4, between about 1 and about 3.5, between about 1 and about 3, or between about 1 and about 2. In some embodiments, a ratio of the calcined clay to the filler in the calcined soil of the fiber cement composite formulation is between about 0.1 and about 1, for example, between about 0.2 and about 0.9, between about 0.3 and about 0.8, between about 0.4 and about 0.7, between about 0.5 and about 0.6, between about 0.1 and about 0.5, or between about 0.1 and about 0.4.

The fiber cement composite formulations disclosed herein can include silica (for example, ground sand or fine quartz). In some embodiments, the fiber cement composite formulation comprises between about 10% and about 80% by dry weight of silica, for example, between about 15% and about 75%, between about 20% and about 70%, between about 25% and about 65%, between about 30% and about 60%, between about 35% and about 55%, between about 40% and about 50%, between about 30% and about 80%, between about 30% and about 75%, between about 30% and about 70%, between about 30% and about 65%, between about 30% and about 60%, between about 30% and about 70%, between about 35% and about 70%, between about 10% and about 70%, between about 40% and about 70%, or between about 40% and about 60% by dry weight of silica, or any value or range within or bounded by any of these ranges or values. In some embodiments, the fiber cement composite formulation comprises less than about 70% by dry weight of silica, for example, less than about 65%, less than about 60%, less than about 55%, less than about 50%, less than about 45%, less than about 40%, less than about 35%, or less than about 35% by dry weight of silica. In some embodiments, the fiber cement composite formulation comprises at least about 10% by dry weight of silica, for example, at least about 15%, at least about 20%, at least about 25%, at least about 30%, at least about 35%, at least about 40%, at least about 45%, at least about 50%, at least about 55%, or at least about 60% by dry weight of silica.

In some embodiments, the silica has a median particle size that is between about 1 μm and about 50 μm, for example, between about 5 μm and about 45 μm, between about 10 μm and about 40 μm, between about 15 μm and about 35 μm, between about 20 μm and about 30 μm, between about 15 μm and about 25 μm, or between about 10 μm and about 25 μm, or any value or range within or bounded by any of these ranges or values.

In some embodiments, the silica has a mean particle size that is between about 1 μm and about 50 μm, for example, between about 5 μm and about 45 μm, between about 10 μm and about 40 μm, between about 15 μm and about 35 μm, between about 20 μm and about 30 μm, or between about 30 μm and about 40 μm, or any value or range within or bounded by any of these ranges or values.

Various embodiments of the disclosed fiber cement composite formulations can include cementitious material as described previously (which can include limestone as discussed above). In some embodiments, an amount of silica in the fiber cement composite formulation is greater than an amount of the cementitious material in the fiber cement composite formulation. In some embodiments, an amount of silica in the fiber cement composite formulation is greater than an amount of cement (for example, ground Portland cement clinker) in the fiber cement composite formulation. In some embodiments, an amount of silica in the fiber cement composite formulation is greater than an amount of limestone in the fiber cement composite formulation. Various embodiments of the disclosed fiber cement composite formulations can include calcined soil and/or calcined clay as described previously. In some embodiments, an amount of silica in the fiber cement composite formulation is greater than an amount of the calcined soil in the fiber cement composite formulation. In some embodiments, an amount of silica in the fiber cement composite formulation is greater than an amount of calcined clay in the fiber cement composite formulation.

The fiber cement composite formulations disclosed herein can include reinforcing fibers. Such reinforcing fibers can be thermomechanically or chemically-refined fibers, such as cellulose fibers produced by the Kraft process, which may be bleached or unbleached. The cellulose fibers (which also may be referred to as “cellulose pulps”) can be made of softwood, hardwood, agricultural raw materials, recycled waste paper or any other forms of lignocellulosic materials. Useful reinforcing cellulose fibers may also include chemically treated cellulose fibers, such as fibers treated with hydrophobicity agents, biocides, etc. Other forms of reinforcing fibers may also be used examples of which include, but are not limited to, ceramic fiber, glass fiber, mineral wool, steel fiber, and synthetic polymer fibers such as polyamides, polyester, polypropylene, polymethylpentene, polyacrylonitrile, polyacrylamide, viscose, nylon, PVC, PVA, rayon, glass ceramic, carbon, or any mixtures thereof. The fiber cement composite formulations disclosed herein can include a blend of one or more types of fibers, for example, a blend of cellulose fibers and polypropylene fibers. In some embodiments in which the fiber cement composite formulation includes both cellulose fibers and polypropylene, the amount of cellulose fibers in the blend is higher than the amount of polypropylene fibers.

In some embodiments, the fiber cement composite formulation comprises between about 0.5% and about 15% by dry weight of fibers (for example, cellulose fibers), for example, between about 1% and about 15%, between about 2% and about 14%, between about 3% and about 13%, between about 4% and about 12%, between about 5% and about 11%, between about 6% and about 10%, between about 7% and about 9%, between about 5% and about 15%, between about 5% and about 10%, between about 5% and about 9%, or between about 5% and about 7% by dry weight of fibers (for example, cellulose fibers), or any value or range within or bounded by any of these ranges or values.

The fiber cement composite formulations disclosed herein can include one or more density modifiers (which may also be referred to as “low density additives”). Such density modifiers can have a loose bulk density of about 0.8 g/cm³ (about 50 lbs./cu. ft.) or less, for example. Examples of density modifiers that can be utilized in the fiber cement composite formulations disclosed herein include low bulk density calcium silicate hydrates (CSH), expanded polystyrene beads (EPS), expanded vermiculite, expanded perlite, expanded shale, expanded clay, and fly ash derived and/or synthetic ceramic microspheres. The fiber cement composite formulations disclosed herein can include between about 1% and about 12% by dry weight of at least one density modifier, for example, between about 2% and about 11%, between about 3% and about 10%, between about 4% and about 9%, between about 5% and about 8%, between about 6% and about 7%, between about 4% and about 10%, between about 2% and about 12% by dry weight of at least one density modifier, or any value or range within or bounded by any of these ranges or values.

The fiber cement composite formulations disclosed herein can include one or more additives. Such additives can be mineral oxides, hydroxides and fire retardants such as magnesite, thickeners, silica fume or amorphous silica, colorants, pigments, water sealing agents, water reducing agents, setting rate modifiers, hardeners. filtering aids, plasticizers, dispersants, foaming agents or flocculating agents, water-proofing agents, density modifiers or other processing aids. In some embodiments, the fiber cement composite formulation comprises between about 0% and about 40% by dry weight of additive(s) (such as any one or more of the above-described additives), for example, between about 0.5% and about 40%, between about 0.5% and about 35%, between about 0.5% and about 30%, between about 0.5% and about 25%, between about 0.5% and about 20%, between about 0.5% and about 15%, between about 0.5% and about 10%, between about 0.5% and about 5%, between about 1% and about 10%, or between about 1% and about 5% by dry weight of additive(s), or any value or range within or bounded by any of these ranges or values.

Disclosed embodiments of the fiber cement composite formulations include synergistic amounts of cement, limestone (for example, as part of a cementitious material), calcined clay (which can be part of included calcined soil), silica, and fibers that desirably react with one another in an autoclave-cure environment to form durable phases which exhibit surprisingly high strength, durability, and dimensional stability characteristics in cured fiber cement products.

In some embodiments, a ratio of silica to cementitious material in the fiber cement composite formulation is between about 1 and about 8, for example, between about 1.5 and about 7.5, between about 2 and about 7, between about 2.5 and about 6.5, between about 3 and about 6, between about 3.5 and about 5.5, between about 4 and about 5, between about 1 and about 5, between about 1 and about 4, between about 1 and about 3, or between about 2 and about 4.

In some embodiments, a ratio of silica to Portland cement (for example, ground Portland cement clinker) in the fiber cement composite formulation is between about 1 and about 8, for example, between about 1.5 and about 7.5, between about 2 and about 7, between about 2.5 and about 6.5, between about 3 and about 6, between about 3.5 and about 5.5, between about 4 and about 5, between about 1 and about 5, between about 1 and about 4, or between about 1 and about 3, or between about 2 and about 4.

In some embodiments, a ratio of silica to limestone in the fiber cement composite formulation is between about 10 and about 30, for example, between about 10 and about 25, between about 10 and about 20, between about 10 and about 15, between about 15 and about 30, between about 15 and about 25, between about 15 and about 20, or between about 25 and about 30.

In some embodiments, a ratio of silica to calcined soil in the fiber cement composite formulation is between about 10 and about 20, for example, between about 11 and about 19, between about 12 and about 18, between about 13 and about 17, between about 14 and about 16, between about 15 and about 20, or between about 15 and about 17.

In some embodiments, a ratio of silica to calcined clay in the fiber cement composite formulation is between about 40 and about 70, for example, between about 45 and about 65, between about 50 and about 60, between about 45 and about 70, or between about 50 and about 70.

In some embodiments, a ratio of calcined soil to cementitious material in the fiber cement composite formulation is between about 0.1 and about 1, for example, between about 0.1 and about 0.9, between about 0.2 and about 0.8, between about 0.3 and about 0.7, between about 0.4 and about 0.6, between about 0.2 and about 0.6, between about 0.1 and about 0.5, between about 0.1 and about 0.4, or between about 0.1 and about 0.3.

In some embodiments, a ratio of calcined soil to Portland cement (for example, ground Portland cement clinker) in the fiber cement composite formulation is between about 0.1 and about 1, for example, between about 0.1 and about 0.9, between about 0.2 and about 0.8, between about 0.3 and about 0.7, between about 0.4 and about 0.6, between about 0.2 and about 0.7, between about 0.1 and about 0.5, between about 0.1 and about 0.4, or between about 0.1 and about 0.3.

In some embodiments, a ratio of calcined soil to limestone in the fiber cement composite formulation is between about 0.5 and about 5, for example, between about 1 and about 4.5, between about 1.5 and about 4, between about 2 and about 3.5, between about 2.5 and about 3, between about 1 and about 5, between about 1 and about 4, between about 1 and about 3, between about 1 and about 2, between about 2 and about 5, or between about 3 and about 4.

In some embodiments, a ratio of calcined clay to cementitious material in the fiber cement composite formulation is between about 0.01 and about 0.1, for example, between about 0.02 and about 0.09, between about 0.03 and about 0.08, between about 0.04 and about 0.07, between about 0.05 and about 0.06, between about 0.03 and about 0.05, between about 0.01 and about 0.06, or between about 0.04 and about 0.05. In some embodiments, a ratio of calcined clay to cementitious material in the fiber cement composite formulation is less than about 0.1, less than about 0.09, less than about 0.08, less than about 0.07, less than about 0.06, or less than about 0.05.

In some embodiments, a ratio of calcined clay to Portland cement (for example, ground Portland cement clinker) in the fiber cement composite formulation is between about 0.01 and about 0.1, for example, between about 0.02 and about 0.09, between about 0.03 and about 0.08, between about 0.04 and about 0.07, between about 0.05 and about 0.06, between about 0.01 and about 0.08, or between about 0.04 and about 0.05. In some embodiments, a ratio of calcined clay to Portland cement (for example, ground Portland cement clinker) in the fiber cement composite formulation is less than about 0.1, less than about 0.09, less than about 0.08, less than about 0.07, or less than about 0.06.

In some embodiments, a ratio of calcined clay to limestone in the fiber cement composite formulation is between about 0.1 and about 1, for example, between about 0.2 and about 0.9, between about 0.3 and about 0.8, between about 0.4 and about 0.7, between about 0.5 and about 0.6, between about 0.1 and about 0.5, between about 0.2 and about 0.6, or between about 0.3 and about 0.5. In some embodiments, a ratio of calcined clay to limestone in the fiber cement composite formulation is less than about 1, for example, less than about 0.9, less than about 0.8, less than about 0.7, less than about 0.6, less than about 0.5, or less than about 0.4.

As mentioned above, embodiments of fiber cement composite formulations disclosed herein can include cementitious materials that include limestone. For example, various embodiments of cementitious materials disclosed herein comprise between about 5% and about 20% by dry weight of limestone. In some embodiments, the fiber cement composite formulation includes an additional quantity of limestone separate from the limestone that is present in the cementitious material. For example, the limestone present in the cementitious material can represent a first quantity of limestone of the fiber cement composite formulation and the fiber cement composite formulation can include a second quantity of limestone that is separate from such first quantity. In some embodiments, the second quantity of limestone comprises a mean particle size that is between about 1 μm and about 50 μm, for example, between about 5 μm and about 45 μm, between about 10 μm and about 40 μm, between about 15 μm and about 35 μm, between about 20 μm and about 30 μm, or any value or range within or bounded by any of these ranges or values.

In some embodiments, the first quantity of limestone comprises between about 1% and about 5% of the dry weight of the fiber cement composite formulation and the second quantity of limestone comprises between about 1% and about 20% of the dry weight of the fiber cement composite formulation. For example, the first quantity of limestone can comprise about 1%, about 2%, about 3%, about 4%, or about 5% of the dry weight of the fiber cement composite formulation and the second quantity of limestone can comprise about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% of the dry weight of the fiber cement composite formulation. The first quantity of limestone can comprise between about 1% and about 4%, between about 1% and about 3%, or between about 1% and about 2% of the dry weight of the fiber cement composite formulation. The second quantity of limestone can comprise between about 2% and about 19%, between about 3% and about 18%, between about 4% and about 17%, between about 5% and about 16%, between about 6% and about 15%, between about 7% and about 14%, between about 8% and about 13%, between about 9% and about 12%, between about 10% and about 11%, between about 1% and about 3%, between about 6% and about 10%, or between about 15% and about 20% of the dry weight of the fiber cement composite formulation. In some embodiments, the first quantity of limestone is less than the second quantity of limestone.

In some embodiments, a total amount of limestone in the fiber cement composite formulation (for example, that includes the first and second quantities of limestone) comprises between 1% and 20% of the dry weight of the fiber cement composite formulation, for example, between about 2% and about 19%, between about 3% and about 18%, between about 4% and about 17%, between about 5% and about 16%, between about 6% and about 15%, between about 7% and about 14%, between about 8% and about 13%, between about 9% and about 12%, between about 10% and about 11%, between about 1% and about 10%, between about 1% and about 5%, between about 1% and about 3%, between about 5% and about 15%, between about 8% and about 12%, or between about 15% and about 20% of the dry weight of the fiber cement composite formulation.

In some embodiments, a ratio of the silica to the total amount of limestone in the fiber cement composite formulation is between about 1 and about 15, for example, between about 2 and about 14, between about 3 and about 13, between about 4 and about 12, between about 5 and about 11, between about 6 and about 10, or between about 7 and about 9. In some embodiments, a ratio of the calcined soil to the total amount of limestone in the fiber cement composite formulation is between about 0.1 and about 1, for example, between about 0.2 and about 0.9, between about 0.3 and about 0.8, between about 0.4 and about 0.7, or between about 0.5 and about 0.6. In some embodiments, a ratio of the calcined clay to the total amount of limestone in the fiber cement composite formulation is between about 0.01 and about 0.5, for example, between about 0.01 and about 0.4, between about 0.02 and about 0.3, between about 0.03 and about 0.2, between about 0.04 and about 0.1, between about 0.05 and about 0.09, between about 0.06 and about 0.08, or between about 0.05 and about 0.2.

In some embodiments, the fiber cement composite formulation includes silica having a reduced particle size. For example, the fiber cement composite formulation can include silica (for example, ground sand or fine quartz) having a mean particle size that is between about 1 μm and about 20 μm, for example, between about 2 μm and about 19 μm, between about 3 μm and about 18 μm, between about 4 μm and about 17 μm, between about 5 μm and about 16 μm, between about 6 μm and about 15 μm, between about 7 μm and about 14 μm, between about 8 μm and about 13 μm, between about 9 μm and about 12 μm, between about 10 μm and about 11 μm, between about 1 μm and about 15 μm, between about 5 μm and about 20 μm, between about 5 μm and about 15 μm, between about 10 μm and about 20 μm, or between about 10 μm and about 15 μm. As another example, the fiber cement composite formulation can include silica having a mean particle size that is less than about 20 μm, less than about 19 μm, less than about 18 μm, less than about 17 μm, less than about 16 μm, less than about 15 μm, less than about 14 μm, less than about 13 μm, less than about 12 μm, less than about 11 μm, or less than about 10 μm. Such particle sizes can yield greater reactivity of the silica with other components of the fiber cement composite formulation (for example, cement, calcined clay, limestone, and fibers) during an autoclave-cure process. Given such greater reactivity, an amount of silica included in the fiber cement composite formulation can be reduced in some embodiments. For example, in some embodiments, the fiber cement composite formulation comprises less than about 50% by dry weight of silica, for example, less than about 45%, less than about 40%, less than about 35%, less than about 30%, less than about 25%, or less than about 20% by dry weight of silica. In some embodiments, the fiber cement composite formulation comprises between about 10% and about 40% by dry weight of silica, for example, between about 15% and about 35%, between about 20% and about 30%, between about 15% and about 40%, between about 20% and about 40%, between about 25% and about 40%, between about 30% and about 40%, or between about 35% and about 40% by dry weight of silica. In some of such embodiments, an amount of limestone in the fiber cement composite formulation is increased in view of the reduction of the amount of silica. In some embodiments, the fiber cement composite formulation includes between about 20% and about 60% by dry weight of limestone, for example, between about 25% and about 55%, between about 30% and about 50%, between about 35% and about 45%, between about 30% and about 45%, between about 20% and about 55%, between about 20% and about 50%, or between about 25% and about 50% by dry weight of limestone. Such limestone can have a mean and/or median particle size that is similar or identical to any of those listed elsewhere herein with respect to limestone.

In some embodiments, a ratio of Portland cement (for example, ground Portland cement clinker) to limestone in the fiber cement composite formulation is between about 0.1 and about 1, for example, between about 0.2 and about 0.9, between about 0.3 and about 0.8, between about 0.4 and about 0.7, between about 0.5 and about 0.6, or between about 0.4 and about 0.8. In some embodiments, the ratio of Portland cement to limestone in the fiber cement composite formulation is less than about 1, for example, less than about 0.9, less than about 0.8, less than about 0.7, less than about 0.6, less than about 0.5, or less than about 0.4. In some embodiments, a ratio of silica to calcined soil in the fiber cement composite formulation is between about 1 and about 10, for example, between about 2 and about 9, between about 3 and about 8, between about 4 and about 7, between about 5 and about 6, or between about 4 and about 8. In some embodiments, a ratio of silica to calcined clay in the fiber cement composite formulation is between about 5 and about 30, for example, between about 10 and about 25, between about 15 and about 20, between about 10 and about 25, between about 20 and about 30, between about 5 and about 15, or between about 6 and about 12. In some embodiments, a ratio of calcined soil to limestone in the fiber cement composite formulation is between about 0.05 and about 0.5, for example, between about 0.06 and about 0.4, between about 0.07 and about 0.3, between about 0.08 and about 0.2, between about 0.09 and about 0.1, between about 0.08 and about 0.4, between about 0.09 and about 0.3, between about 0.1 and about 0.2, between about 0.1 and about 0.5, between about 0.1 and about 0.4, between about 0.1 and about 0.3, between about 0.2 and about 0.5, or between about 0.3 and about 0.5. In some embodiments, a ratio of calcined clay to Portland cement in the fiber cement composite formulation is between about 0.01 and about 0.3, for example, between about 0.02 and about 0.2, between about 0.03 and about 0.1, between about 0.04 and about 0.09, between about 0.05 and about 0.08, between about 0.06 and about 0.07, between about 0.05 and about 0.2, between about 0.04 and about 0.2, between about 0.01 and about 0.1, between about 0.04 and about 0.06, or between about 0.1 and about 0.3. In some embodiments, a ratio of calcined clay to limestone in the fiber cement composite formulation is between about 0.01 and about 0.3, for example, between about 0.02 and about 0.2, between about 0.03 and about 0.1, between about 0.04 and about 0.09, between about 0.05 and about 0.08, between about 0.06 and about 0.07, between about 0.05 and about 0.2, between about 0.1 and about 0.2, or between about 0.01 and about 0.2. In some embodiments, a ratio of silica to limestone in the fiber cement composite formulation is between about 0.2 and about 1.4, for example, between about 0.3 and about 1.3, between about 0.4 and about 1.2, between about 0.5 and about 1.1, between about 0.6 and about 1, between about 0.7 and about 0.9, between about 0.2 and about 1, between about 0.2 and about 0.7, between about 0.3 and about 0.8, between about 0.4 and about 0.7, between about 1 and about 1.4, or between about 1 and about 1.3.

### Manufacturing Methods

The present disclosure provides various embodiments of fiber cement composite formulations and fiber cement products (for example, fiber cement building articles). Fiber cement composite formulations and fiber cement products can include cement (for example, ordinary Portland cement), limestone, calcined clay (for example, as part of calcined soil), silica, and fibers. Some embodiments additionally include other components such as density modifiers and/or additives (for example, any of those disclosed herein). The amount of cement can be any of the amounts described above with respect to the Portland cement. The amount of limestone can be any of the amounts described above. The limestone in the fiber cement composite formulations and fiber cement products can be provided as part of a cementitious material including Portland cement (for example, as described previously) and/or separate from such cementitious material. The amount of calcined clay, calcined soil, silica, and fibers can be any of the amounts disclosed herein. The components of fiber cement composite formulations can be combined and/or mixed in a variety of ways prior to and/or during the manufacturing process wherein fiber cement products are formed, for example, in accordance with any of the methods disclosed herein.

Components of the fiber cement composite formulations disclosed herein may be formed into “green shaped” fiber cement products (for example, building articles) from a waterborne mixture or slurry by a number of processes, including but not limited to: Hatschek sheet process; Mazza pipe process; Magnani process; Injection molding; Extrusion; Hand lay-up; Molding; Casting; Filter pressing; Flow on machine, roll forming, etc., with or without post pressing.

Various curing methods can be utilized to remove water content to form solid, hardened fiber cement products. For example, the fiber cement products can be autoclave cured in a steam pressurized vessel at a temperature that is between about 120 °C and about 200 °C (for example, between about 130 °C and about 190 °C, between about 140 °C and about 180 °C, between about 150 °C and about 170 °C, or between about 150 °C and about 160 °C). Such autoclave curing can be for a time period between about 4 hours and about 24 hours (for example, between about 5 hours and about 20 hours, between about 6 hours and about 19 hours, between about 7 hours and about 18 hours, between about 8 hours and about 17 hours, between about 9 hours and about 16 hours, between about 10 hours and about 15 hours, between about 11 hours and about 14 hours, between about 12 hours and about 13 hours, between about 8 hours and about 14 hours, between about 6 hours and about 16 hours, or between about 10 hours and about 14 hours). Cured fiber cement products manufactured from the formulations disclosed herein can be used as interior and/or exterior building articles (for example, boards, panels, shingles, planks, or trim building articles).

The fiber cement products can be precured prior to autoclaving. The fiber cement products can be precured at a lower temperature than the temperature used for the autoclave curing process. Such precuring can include subjecting the fiber cement product to a temperature of between about 20 °F and about 150 °F (for example, between about 30 °F and about 140 °F, between about 40 °F and about 130 °F, between about 50 °F and about 120 °F, between about 60 °F and about 110 °F, between about 70 °F and about 100 °F, between about 80 °F and about 90 °F, between about 50 °F and about 140 °F, between about 60 °F and about 130 °F, between about 70 °F and about 120 °F, between about 80 °F and about 110 °F, between about 90 °F and about 100 °F, or between about 40 °F and about 120 °F). Such precuring can include subjecting the fiber cement product to any of the above-described temperatures for a time period between about 4 hours and about 24 hours (for example, between about 5 hours and about 20 hours, between about 6 hours and about 19 hours, between about 7 hours and about 18 hours, between about 8 hours and about 17 hours, between about 9 hours and about 16 hours, between about 10 hours and about 15 hours, between about 11 hours and about 14 hours, between about 12 hours and about 13 hours, between about 4 hours and about 10 hours, or between about 6 hours and about 8 hours). In some embodiments, the time period that the fiber cement product is precured is less than a time period in which the fiber cement product is autoclave cured.

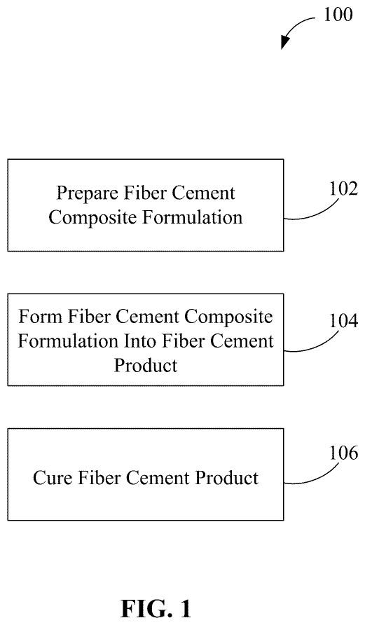

FIG. 1 illustrates an example method 100 of manufacturing a fiber cement product. At step 102, the fiber cement composite formulation is prepared. The fiber cement composite formulation can include any of the components described herein. For example, the fiber cement formulation can include any of the cementitious materials (which can include cement and limestone), calcined clay, calcined soil, silica, fibers (for example, cellulose fibers), and/or other components (for example, one or more density modifiers and/or additives) disclosed herein. Preparation of the fiber cement formulation at step 102 can involve combining these components in a variety of ways, depending on the process utilized in step 104 to form the fiber cement composite formulation into fiber cement product(s). For example, components of the fiber cement formulation can be mixed together and with water to form a slurry.

At step 104, the fiber cement formulation is formed into one or more “green shaped” (uncured) fiber cement products (such as building articles). In some implementations, the fiber cement formulation is formed into one or more “green shaped” (uncured) fiber cement products at step 104 via a Hatschek sheet process.

At step 106, the fiber cement products are cured. Curing at step 106 can include autoclave curing at any of the temperatures described above for any of the time periods described above. In some implementations, step 106 additionally includes precuring, prior to autoclave curing, at any of the temperatures described above for any of the time periods described above with respect to precuring.

The fiber cement composite formulations disclosed herein can formed into fiber cement products, for example, as described above. In some embodiments, the fiber cement products comprise a modulus of rupture (MoR) that is between about 4 MPa and about 14 MPa, for example, between about 5 MPa and about 13 MPa, between about 6 MPa and about 12 MPa, between about 7 MPa and about 11 MPa, between about 8 MPa and about 10 MPa, between about 4 MPa and about 12 MPa, between about 5 MPa and about 12 MPa, between about 6 MPa and about 12 MPa, between about 7 MPa and about 12 MPa, between about 8 MPa and about 12 MPa, between about 9 MPa and about 12 MPa, or between about 10 MPa and about 12 MPa. In some embodiments, the fiber cement products comprise a modulus of rupture (MoR) that is at least about 4 MPa, at least about 5 MPa, at least about 6 MPa, at least about 7 MPa, at least about 8 MPa, at least about 9 MPa, at least about 10 MPa, or at least about 11 MPa. In some embodiments, the fiber cement products comprise an oven dry density that is between about 1 g/cc and about 3 g/cc, for example, between about 1 g/cc and about 2.5 g/cc, between about 1 g/cc and about 2 g/cc, between about 1 g/cc and about 1.5 g/cc, between about 1.1 g/cc and about 2 g/cc, between about 1.2 g/cc and about 1.9 g/cc, between about 1.3 g/cc and about 1.8 g/cc, between about 1.4 g/cc and about 1.7 g/cc, or between about 1.5 g/cc and about 1.6 g/cc. In some embodiments, the fiber cement products comprise an oven dry density that is less than about 4 g/cc, less than about 3.5 g/cc, less than about 3 g/cc, less than about 2.5 g/cc, less than about 2 g/cc, or less than about 1.5 g/cc. In some embodiments, the fiber cement products comprise a moisture movement (MM) that is between about 0.1% and about 0.5%, for example, between about 0.1% and about 0.4%, between about 0.1% and about 0.3%, or between about 0.1% and about 0.2%. In some embodiments, the fiber cement products comprise a moisture movement (MM) that is less than about 0.5%, less than about 0.4%, less than about 0.3%, or less than about 0.2%.

### EXAMPLES

Various bench scale experiments were conducted, examples of which are described below with respect to Tables 1a and 1b. Filter pads of three cellulose fiber cement composite formulations (outlined in Table 1a) were prepared without post-pressing according to a conventional procedure which simulates the Hatschek process. In short, components of the formulations were mixed with water to form a slurry and the slurry was then compressed between dewatering plates to form the filter pads. Table 1a lists the amount of cellulose fibers, silica, Portland cement (Ordinary Portland Cement), limestone, and calcined soil as a percentage of the dry weight of each formulation. Formulation 1 included silica (ground sand) having a mean particle size of 25 μm. Formulations 2 and 3 included silica (ground sand) having a mean particle size of 12 μm. Formulation 1 incorporated calcined soil that included 67% by dry weight of calcined clay (dehydroxylated kaolinite). Formulations 2 and 3 incorporated calcined soil that included 43% by dry weight of calcined clay (dehydroxylated kaolinite).

TABLE 1a

| | | | Portland | | |
|---|---|---|---|---|---|
| | Cellulose | Silica | Cement | Limestone | Calcined Soil |
| Formulation | Fibers (%) | (%) | (%) | (%) | (%) |
| 1 | 6.5 | 54.1 | 27.5 | 3.9 | 8.0 |
| 2 | 6.0 | 37.0 | 18.9 | 30.0 | 8.1 |
| 3 | 7.0 | 32.0 | 21.7 | 30.0 | 9.3 |

The pads were autoclave-cured for eight hours at 180 °C and then tested for saturated flexural strength and dry density in accordance with ASTM C 1185. Results are shown in Table 1b. All three formulations complied with ASTM C1186 Grade II requirement for exterior applications (i.e., minimum Wet (Saturated) Strength of 7 MPa). As shown, the formulations demonstrated high flexural strength characteristics.

TABLE 1b

| Formulation | Saturated MoR (MPa) | Dry Density (g/cc) |
|---|---|---|
| 1 | 10.2 | 1.37 |
| 2 | 8.5 | 1.39 |
| 3 | 8.6 | 1.39 |

### ADDITIONAL CONSIDERATIONS

Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as any subcombination or variation of any subcombination.

Moreover, while methods may be described in the specification in a particular order, such methods need not be performed in the particular order shown or in sequential order, and that all methods need not be performed, to achieve desirable results. Other methods that are not depicted or described can be incorporated in the example methods and processes. For example, one or more additional methods can be performed before, after, simultaneously, or between any of the described methods. Further, the methods may be rearranged or reordered in other implementations. Also, the separation of various system components in the implementations described above should not be understood as requiring such separation in all implementations, and it should be understood that the described components and systems can generally be integrated together in a single product or packaged into multiple products. Additionally, other implementations are within the scope of this disclosure.

Conditional language, such as “can,” “could,” “might,” or “may,” unless specifically stated otherwise, or otherwise understood within the context as used, is generally intended to convey that certain embodiments include or do not include, certain features, elements, and/or steps. Thus, such conditional language is not generally intended to imply that features, elements, and/or steps are in any way required for one or more embodiments.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally” and “substantially” may refer to an amount that is within less than or equal to 10% of, within less than or equal to 5% of, or within less than or equal to 1% of the stated value, amount, or characteristic.

Although making and using various embodiments are discussed in detail herein, it should be appreciated that the description provides many inventive concepts that may be embodied in a wide variety of contexts. The specific aspects and embodiments discussed herein are merely illustrative of ways to make and use the formulations, products, and methods disclosed herein and do not limit the scope of the disclosure. The components and methods described herein may be used for formulation of cementitious and/or fiber cement building articles and are described herein with reference to this application. However, it will be appreciated that the disclosure is not limited to this particular field of use.

1. A fiber cement composite formulation comprising:
between 10% and 40% by dry weight of a cementitious material, said cementitious material comprising:
between 80% and 95% by dry weight of ground Portland cement clinker having a median particle size between 10 μm and 30 μm; and
between 5% and 20% by dry weight of limestone having a median particle size between 5 μm and 30 μm;
between 0.5% and 20% by dry weight of calcined soil, said calcined soil comprising:
between 20% and 90% by dry weight of calcined clay having a median particle size between 5 μm and 30 μm, said calcined clay comprising metakaolin; and
between 10% and 80% by dry weight of a filler comprising quartz having a median particle size between 200 μm and 800 μm;
between 30% and 70% by dry weight of silica having a median particle size between 5 μm and 40 μm; and
between 1% and 15% by dry weight of cellulose fibers;
wherein the fiber cement composite formulation is configured to be autoclave-cured in a steam pressurized vessel at a temperature of at least 150 °C to form a solid fiber cement building article.

2. (canceled)

3. (canceled)

4. (canceled)

5. The fiber cement composite formulation of claim 1, wherein said fiber cement composite formulation comprises less than 30% by dry weight of said ground Portland cement clinker.

6. (canceled)

7. (canceled)

8. The fiber cement composite formulation of claim 1, wherein said median particle size of said limestone is between 9 μm and 25 μm.

9. (canceled)

10. (canceled)

11. (canceled)

12. (canceled)

13. The fiber cement composite formulation of claim 1, wherein a ratio of said calcined clay to said filler in said calcined soil is between 0.1 and 0.5.

14. (canceled)

15. (canceled)

16. (canceled)

17. (canceled)

18. The fiber cement composite formulation of claim 1, wherein said fiber cement composite formulation comprises between 5% and 10% by dry weight of said cellulose fibers.

19. (canceled)

20. (canceled)

21. (canceled)

22. (canceled)

23. (canceled)

24. (canceled)

25. (canceled)

26. The fiber cement composite formulation of claim 1, wherein a ratio of said calcined soil to said limestone in the fiber cement composite formulation is between 1 and 2.

27. (canceled)

28. (canceled)

29. The fiber cement composite formulation of claim 1, wherein a ratio of said calcined clay to said limestone in the fiber cement composite formulation is between 0.1 and 0.5.

30. (canceled)

31. (canceled)

32. (canceled)

33. (canceled)

34. A fiber cement building article comprising the fiber cement composite formulation of claim 1.

35. (canceled)

36. A fiber cement composite formulation comprising:
between 10% and 40% by dry weight of a cementitious material, said cementitious material comprising at least 5% by dry weight of limestone;
between 0.5% and 10% by dry weight of calcined clay;
silica; and
between 1% and 15% by dry weight of fibers;
wherein the fiber cement composite formulation is configured to be autoclave-cured in a steam pressurized vessel at a temperature of at least 150 °C to form a solid fiber cement building article.

37. The fiber cement composite formulation of claim 36, wherein said cementitious material further comprises ground Portland cement clinker.

38. The fiber cement composite formulation of claim 37, wherein said cementitious material comprises between 80% and 95% by dry weight of said ground Portland cement clinker and between 5% and 20% by dry weight of said limestone.

39. (canceled)

40. (canceled)

41. (canceled)

42. (canceled)

43. (canceled)

44. (canceled)

45. (canceled)

46. (canceled)

47. (canceled)

48. The fiber cement composite formulation of claim 36, wherein said fiber cement composite formulation comprises between 1% and 20% by dry weight of calcined soil, said calcined soil comprising between 20% and 90% by dry weight of said calcined clay and between 10% and 80% by dry weight of a filler.

49. (canceled)

50. (canceled)

51. (canceled)

52. (canceled)

53. (canceled)

54. (canceled)

55. The fiber cement composite formulation of claim 48, wherein a ratio of said calcined clay to said filler in said calcined soil is between 0.1 and 0.5.

56. The fiber cement composite formulation of claim 48, wherein said filler comprises quartz.

57. The fiber cement composite formulation of claim 36, wherein said calcined clay comprises metakaolin.

58. (canceled)

59. (canceled)

60. (canceled)

61. (canceled)

62. (canceled)

63. The fiber cement composite formulation of claim 36, wherein said fibers comprise cellulose fibers.

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. A fiber cement building article comprising the fiber cement composite formulation of claim 36.

81. (canceled)

82. (canceled)

83. (canceled)

84. (canceled)

85. (canceled)

86. (canceled)

87. (canceled)

88. (canceled)

89. (canceled)

90. (canceled)

91. (canceled)

92. (canceled)

93. (canceled)

94. (canceled)

95. (canceled)

96. (canceled)

97. (canceled)

98. (canceled)

99. (canceled)

100. (canceled)

101. (canceled)

102. (canceled)

103. (canceled)

104. (canceled)

105. (canceled)

106. (canceled)

107. (canceled)

108. (canceled)

109. (canceled)

110. (canceled)

111. (canceled)

112. (canceled)

113. (canceled)

114. (canceled)

115. (canceled)

116. (canceled)

117. (canceled)

118. (canceled)

119. (canceled)

120. A fiber cement composite formulation comprising:
between 10% and 30% by dry weight of Portland cement;
between 10% and 40% by dry weight of silica having a mean particle size between 1 μm and 20 μm;
between 20% and 60% by dry weight of limestone;
between 0.5% and 10% by dry weight of calcined clay; and
between 1% and 15% by dry weight of fibers.

121. (canceled)

122. (canceled)

123. (canceled)

124. (canceled)

125. (canceled)

126. (canceled)

127. (canceled)

128. (canceled)

129. (canceled)

130. (canceled)

131. (canceled)

132. (canceled)

133. (canceled)

134. A fiber cement building article comprising the fiber cement composite formulation of claim 120.

135. (canceled)
